(19) United States
(12) Patent Application Publication
(10) Pub. No.: US 2005/0094632 A1
(43) Pub. Date: May 5, 2005

(54) DOCSIS MAC layer-based ARQ for fixed wireless

(76) Inventors: Anders Hebsgaard, Frederiksberg (DK); Mark Dale, Laguna Hills, CA (US)

Correspondence Address: James A. Harrison, P.O. Box 670007, Dallas, TX, 75367, US

(21) Appl. No.: 10/698,055

(22) Filed: Oct. 30, 2003

(51) Int. Cl. H04L 12/28

(52) U.S. Cl. 370/389

(57) ABSTRACT

An apparatus and method of the present invention includes implementing an automatic repeat request (ARQ) protocol in a DOCSIS wireless environment for fixed wireless applications. More specifically, an ARQ protocol is implemented at the medium access control (MAC) layer to provide fast response relative to convention ARQ protocols and logic that are implemented at higher layers (e.g., TCP/IP) in the OSI layered approach to system architecture and design. To achieve this result, a DOCSIS defined signal and header is modified to include an ARQ header containing various ARQ parameters. While some known approaches to ARQ involve retransmission of entire frames or blocks, the present invention contemplates provide control down to the packet data unit (PDU) level. To achieve this level of granularity, the ARQ header includes sequence numbers within each ARQ header. Accordingly, a transmitter re-transmits a lost transmission whenever it receives a “non-acknowledge” signal advising it of the failure and of the identity of the missing PDU.

### CROSS REFERENCE TO RELATED APPLICATIONS

This application incorporates by reference the following U.S. Non-Provisional Patent Applications each of which includes at least one of Anders Hebsgaard or Mark Dale as inventor:
(1) U.S. patent application Ser. No. 09/430,821, filed Oct. 29, 1999, by Hebsgaard, et al., and incorporated herein by reference in its entirety;
(2) U.S. patent application Ser. No. 09/574,558, filed May 19, 2000, by Hebsgaard, et al., and incorporated herein by reference in its entirety;
(3) U.S. patent application Ser. No. 09/653,155, filed Aug. 31, 2000, by Hebsgaard, et al., and incorporated herein by reference in its entirety; and
(4) U.S. patent application Ser. No. 10/097,942, filed Mar. 15, 2002, by Dale, et al., and incorporated herein by reference in its entirety;

### BACKGROUND OF THE INVENTION

1. Field of the Invention

This invention relates to the field of data communications, and more particularly to increasing data transmission reliability for Fixed Wireless Applications.

2. Description of the Related Art

Data comniunications network and device designers are continually striving to increase capacity, increase throughput, improve efficiency and improve overall operations according to need. As such, many use specific designs are being pursued that are appropriate for particular operations. For example, an entire fixed wireless industry has developed for providing wireless service to relative non-mobile users. Heretofore, the fixed wireless industry has utilized known cellular standards such is IS-95 code division multiple access protocols and technology for delivering fixed wireless cellular service to the subscriber. The fixed wireless service was originally implemented as a carrier service, initially intended for broadcast of television, and has commonly been referred to as wireless cable. In the United States, this service is available at 2.5 GHz. The service is usually analog and one way (transmit only), with a range of about 30 miles (50 km), and has been deployed in the United States, the Middle East, Latin America, Eastern Europe and Asia Pacific. Carriers have not been successful with television programming and have instead been able to offer two-way service for Internet. Others offer Internet service by using a hybrid approach with a PSTN (public switched telephone network) connection for the return path. Two-way service reduces the effective range of MMDS to about 6 miles (10 km).

Since the inception of fixed wireless networks, however, digital subscriber lines, cable modems and other broadband access technologies have emerged enabling their users to achieve fast internet service in relation to dial up subscriber speeds. The Data-Over-Cable Service Interface Specification (DOCSIS) was defined to promote interoperability among cable modems and other related products. It has been modified by the Broadband Wireless Internet Forum (BWIF), however, to be used in fixed wireless point to multipoint distribution services using physical layers such as orthogonal frequency division multiplexing (OFDM). Because wireless signals are more susceptible to channel problems such as fading, it is desirable to make the wireless data flow more robust to account for transmission errors and interference. Thus, there exists a need for a DOCSIS based fixed wireless system that provides protection for the transmission errors and interference.

### SUMMARY OF THE INVENTION

An apparatus and method of the present invention includes implementing an automatic repeat request (ARQ) protocol to improve the robustness of fixed wireless and other wireless communication systems. Because some systems have adopted an approach of utilizing an adapted DOCSIS protocol for wireless applications, the present invention contemplates modifying the adapted DOCSIS protocol by introducing an ARQ protocol that functions in a DOCSIS wireless environment. More specifically, an ARQ protocol is implemented at the medium access control (MAC) layer to provide fast response relative to conventional ARQ protocols and logic that are implemented at higher layers (e.g., TCP/IP) in the OSI layered approach to system architecture and design. To achieve this result, a DOCSIS defined signal and header is modified to include an ARQ header containing ARQ parameters. While some known approaches to ARQ involve retransmission of entire frames or blocks, the present invention contemplates provide control down to the packet data unit (PDU) level in some embodiments. To achieve this level of granularity, the ARQ header includes sequence numbers within each ARQ header on a packet data unit (PDU) basis. Accordingly, when a receiver, by evaluating sequence numbers for received PDUs determines that it did not received a particular PDU, the receiver generates a “non-acknowledge” signal to the transmitter to advise it of the failure and to identify the missing PDU. As the transmitter includes a buffer that stores all transmitted PDUs for a specified period, the transmitter is able to find the missing or lost PDU and retransmit the missing PDU to the receiver.

### BRIEF DESCRIPTION OF THE DRAWINGS

FIG. 1 is a functional block diagram that illustrates communications between a head end device and a signal unit according to one embodiment of the present invention;

FIG. 2 generally illustrates a transmit window;

FIG. 3 generally illustrates a receive window;

FIG. 4 illustrates the construction of an ARQ data frame header and shows how it is included in a DOCSIS header according to one embodiment of the invention;

FIG. 5 illustrates construction of an ARQ control message header and how it is included in a DOCSIS header according to one embodiment of the present invention;

FIG. 6 illustrates construction of an ARQ control message as a stand alone message within a DOCSIS environment/system according to one embodiment of the invention;

FIG. 7 illustrates an Ethernet header as used in the DOCSIS environment as shown in FIG. 6 according to one embodiment of the invention;

FIG. 8 illustrates the ARQ Control Message part of FIG. 6 in detail according to one embodiment of the invention;

FIG. 9 illustrates a signal flow diagram for setting up and tearing down the ARQ service within a DOCSIS system according to one embodiment of the invention;

FIG. 10 is a diagram that illustrates layout of a MAC layer signal including a transaction ID and TLV encoded information;

FIG. 11 is a flow chart illustrating operation of one embodiment of the invention; and

FIG. 12 is a flow chart illustrating one embodiment of the present invention.

### DETAILED DESCRIPTION OF THE INVENTION

The inventive method and apparatus disclosed herein are particularly advantageous in that they provide a capability for transmitting wireless communication signals in a more robust manner than is provided for, especially for particular networks utilizing protocols such as cable modem protocols that have been adopted for wireless communications. More specifically, the invention makes use of the features of a modified DOCSIS MAC layer to provide the ARQ protocol for fixed wireless applications employing the DOCSIS standard as originated for cable modems but modified for fixed wireless transmissions. In one embodiment of the invention, a selective repeat ARQ is utilized, with negative acknowledge (N-ACK) on all packages, and, more particularly, as a MAC based ARQ for the packages. Here, the ARQ operates on a per PDU basis at the MAC layer. Control is accomplished through messaging. Preferably, the ARQ protocol can be enabled either on a connection or on a per flow basis. Negative acknowledge includes the receiver advising the transmitter when a PDU was not received. When the transmitter has received a negative acknowledge signal, it deletes or flushes all PDUs transmitted prior to the PDU identified in the negative acknowledge signal. Additionally, a transmitter flushes its buffers if, after a specified period, it has not received a N-ACK messag.

One embodiment of the invention is implemented at the MAC layer because it is superior in performance and efficiency over implementing the ARQ protocol on the TC/IP layer or the physical layer. Implementing the ARQ protocol on the TC/IP layer would be very slow and inefficient. In a down stream broadcast environment, a physical layer ARQ would swamp the upstream channel because the N-ACK would have to be issued on a per OFDM burst basis, which is typically only about 64 bytes. Moreover, each of the receiving physical layers have no information regarding whether a missed burst was intended for them, and thus will always notify the head end that the burst was missed.

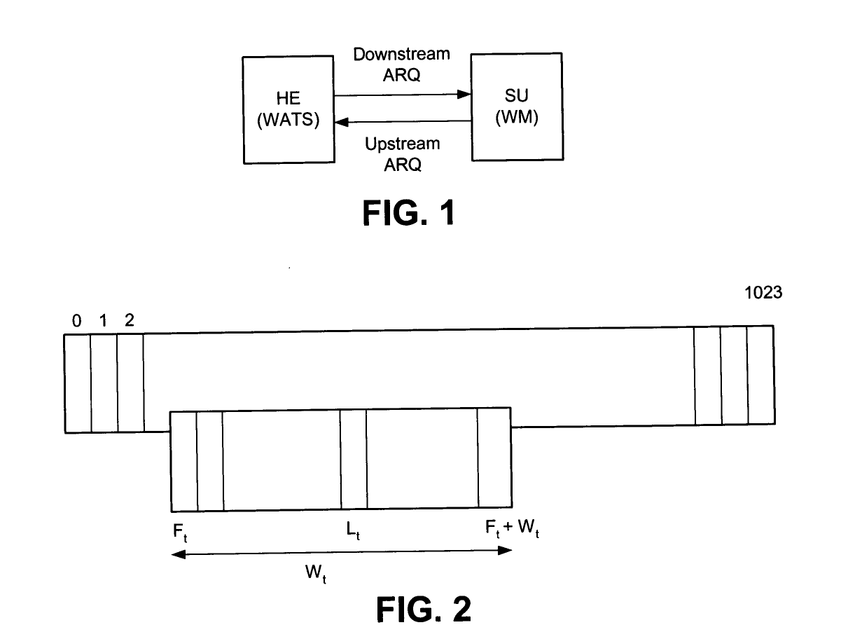

If one assumes a reasonable channel, a selective repeat is used to minimize data amounts and latency in retransmission. The negative or non-acknowledge signal (N-ACK) minimizes the signaling overhead for each packet. An upstream ARQ improves packet delivery from signal unit (SU) 10 to head end (HE) 20 (FIG. 1), while downstream ARQ improves packet delivery from HE 20 to SU 10. The implementation logic is the same in both the upstream and downstream paths.

Upstream ARQ improves packet delivery from SU to HE, while downstream ARQ improves packet delivery from HE to SU. The logic is the same in both the upstream and downstream paths.

General Protocol Features are as Follows:

1. Windowed selective repeat ARQ protocol
2. Sender adds ARQ header to frames and keeps a copy of transmitted frames in transmitter window until it either receives an N-ACK or it times out and assumes the packet was received correctly.
3. Receiver confirms received frames and notifies missing sequence numbers via the negative acknowledgement messages that are sent based on a periodic receiver timer or explicit acknowledgement request from sender.
4. Receiver buffers out-of-sequence frames until in-sequence deliveryis provided.
5. Sender retransmits only missing frames requested by receiver.
6. Sender can send explicit acknowledgement request based on transmitter timeout.
7. The ARQ header that contains control and sequence number information is to be placed in the DOCSIS extended header. General protocol features for one embodiment of the invention are as follows. Windowed selective repeat ARQ protocol is chosen in one embodiment of the invention. In this scheme, a receiver requests retransmission of a specified PDU as identified by a sequence number.

The transmitter adds an ARQ header to the frames and keeps a copy of the transmitted frames in a transmitter window until it either receives a N-ACK or it times out and assumes the packet was received correctly. There are at least three timers utilized in the described embodiment of the invention. They are:
T_{f}-Flush Time
T_{TLT}-Time to live is the maximum time the transmitter has to store a packet for retransmission
T_{TR}-Time to retransmit is the time the receiver must allow between each N-ACK for a packet.

Additionally, the invention includes at least two counters. They are:
Rₜ-Maximum number of retries for transmitting a packet (Infinite for full reliability)
Rᵣ-Maximum number of retries for Request_ACK message (Infinite for full reliability).

Generally, the receiver confirms received frames and notifies missing sequence numbers via the negative acknowledgement messages that are sent based on a periodic receiver time or on an explicit acknowledgement request from the transmitter.

The receiver buffers out-of-sequence frames until in-sequence delivery is provided. The transmitter retransmits only missing frames requested by the receiver. The transmitter can send an explicit acknowledgement request based on a transmitter timeout.

FIG. 2 generally illustrates a transmit window. The ARQ header that contains control and sequence number information is placed in the DOCSIS extended header. A Tx ARQ background process is used to monitor queue and timer events generated by each Tx path (See FIG. 2). For each Tx path, when a packet is received from the application, the sequence number is incremented and the packet is encapsulated with the ARQ header. The encapsulated packet is stored in the transmitter window. If the transmitter buffer is full, recovery is implementation specific. Each time a packet is transmitted over this Tx path, when an N-ACK message is received, the sequence number, SQᵣ field of the N-ACK message is read, and checked to see if it is within the transmitter window. If the sequence number is valid, the transmitter buffer frees locations that hold sequence numbers up to SQᵣ. The sender window is moved to SQᵣ and the sequence number field of the N-ACK message is read. The missing packets are indicated by the N-ACK message as long as individual retry counters for each packet have not exceeded their limit, Rₜ. If the retransmission limit for a packet is reached, the packet is flushed. If the sequence number is not valid, that means it must no longer be in the queue, and the N-ACK message must be sent back to the receiver to indicate that retransmission is impossible.

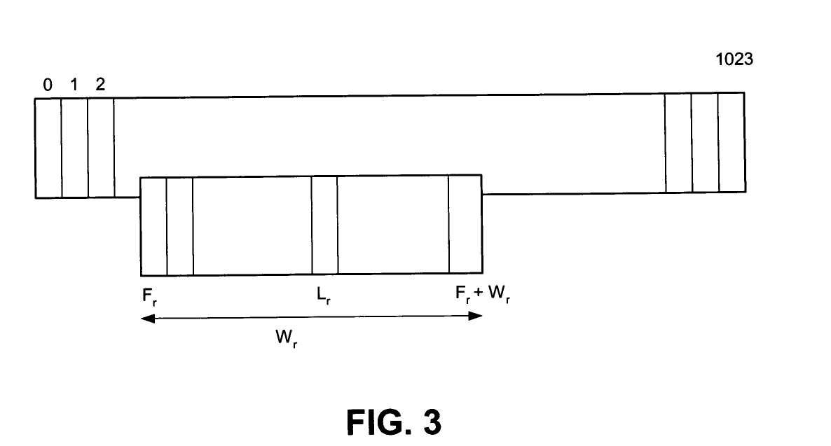

FIG. 3 generally illustrates a receive window. An Rx ARQ background process is used to monitor queue and timer events generated by each Rx path. For each Rx path (See FIG. 3), each time a packet is received, the ARQ header is examined and the sequence number is checked to be valid (i.e. does it fall within the receiver window boundaries?). If the sequence number is valid, the packet is stored in the receiver window at the correct buffer position, according to its sequence number and Fᵣ. The packets in the receiver window are examined, and the new value of first un-received packet is determined as F_{r,new}. All of the packets from Fᵣ to F_{r,new} are released to the application. Fᵣ is updated as F_{r,new}. The packets in the new receive window (after releases) are examined and a N-ACK for all not received packets is constructed. This includes packets that have previously been requested, but not retransmitted with in T_{TL}.

If the sequence number is not valid, all the packets in the current window will be flushed and will be set to the sequence number of the packet received. When a N-ACK message is received all packets up to the sequence number are released, because this means that packets up to that sequence number are no longer live at the transmitter side.

When a Request_NACK message is received, the sequence number field is read from the Request_NACK message. All packets from up to that sequence number are released. The packets in the new receive window (after releases) are examined and the sequence number of all missing packets is constructed. An N-ACK message with the latest missing sequence numbers is then immediately sent, and all packets from Fᵣ up to and including L_{r,init} are flushed.

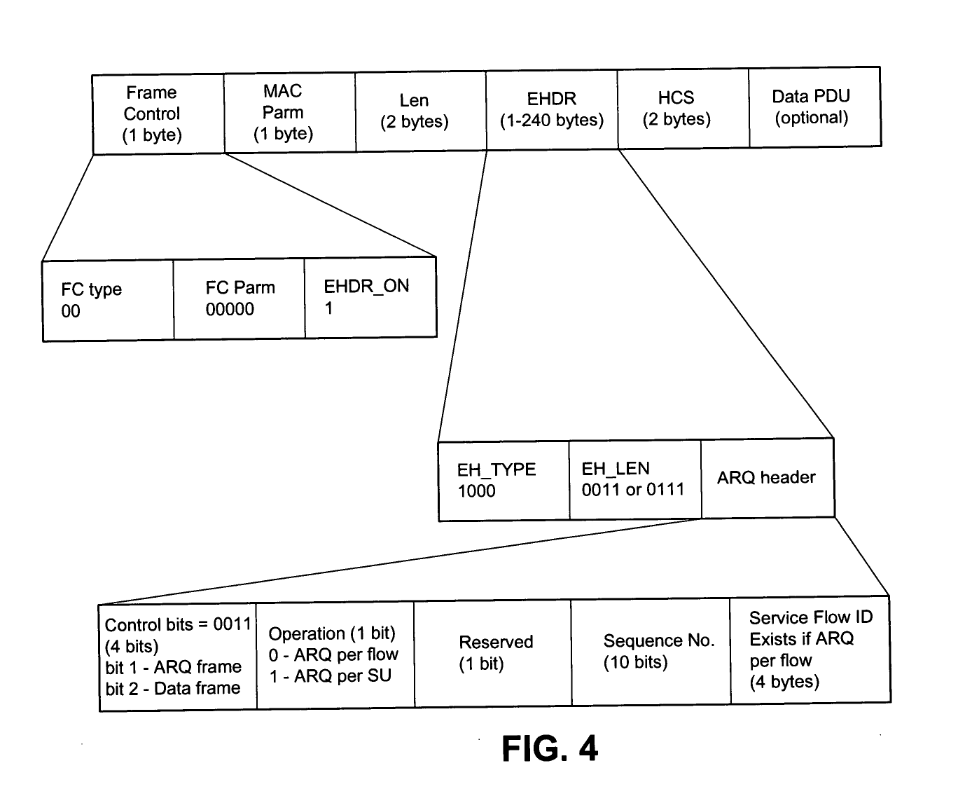

FIG. 4 illustrates the construction of an ARQ data frame header and shows how it is included in a DOCSIS header according to one embodiment of the invention. An ARQ header for a data frame is inserted as an extended header (EHDR). A reserved extended header of EH type=8 is allocated for ARQ. For the ARQ header, an operation bit is used to indicate ARQ. The following diagram shows the format.

Three ARQ control frame formats are proposed as described below. The ARQ can be implemented using either MAC Management Messages or EHDR. The wireless access termination system (WATS) and wireless modem (WM) capabilities are negotiated during the setup of an ARQ session. An ARQ header for control frame is inserted as EHDR header as in the ARQ data frame format. A reserved EH type=8 is allocated for ARQ. For the ARQ header, an operation bit is used to indicate ARQ. The control bits indicate this is an ARQ control frame for Request_ACK message or ACK message. Since EH_LEN field is 4 bits, it limits the size of the bitmap sent to be 104 for ARQ per SU, and 72 for ARQ per flow.

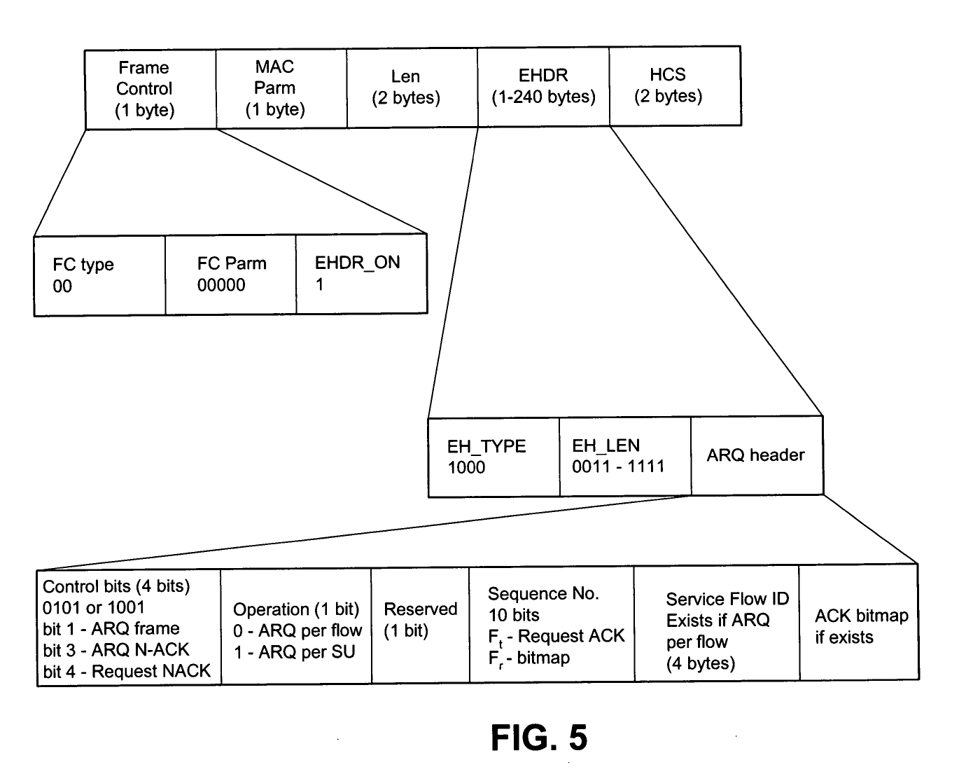

FIG. 5 illustrates construction of an ARQ control message header and how it is included in a DOCSIS header according to one embodiment of the present invention. A new MAC management frame-type=255 is allocated for ARQ as is known by one of average skill in the art.

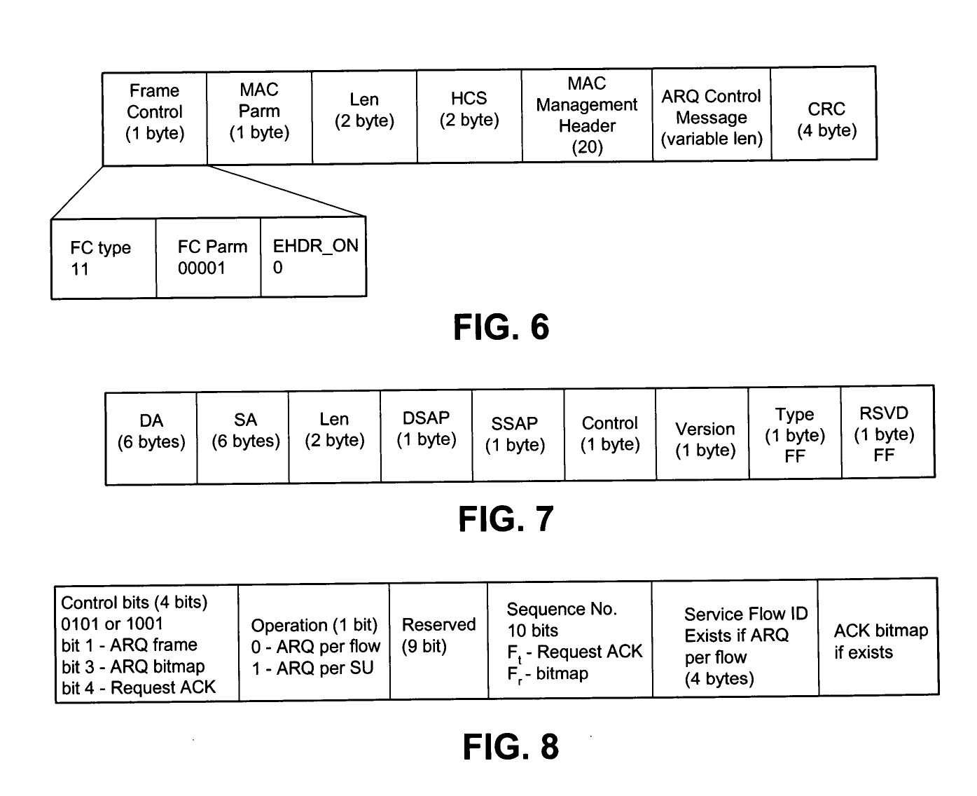

FIG. 6 illustrates construction of an ARQ control message as a stand alone message within a DOCSIS environment/system according to one embodiment of the invention.

FIG. 7 illustrates an Ethernet header as used in the DOCSIS environment as shown in FIG. 6 according to one embodiment of the invention.

FIG. 8 illustrates the ARQ Control Message part of FIG. 6 in detail according to one embodiment of the invention.

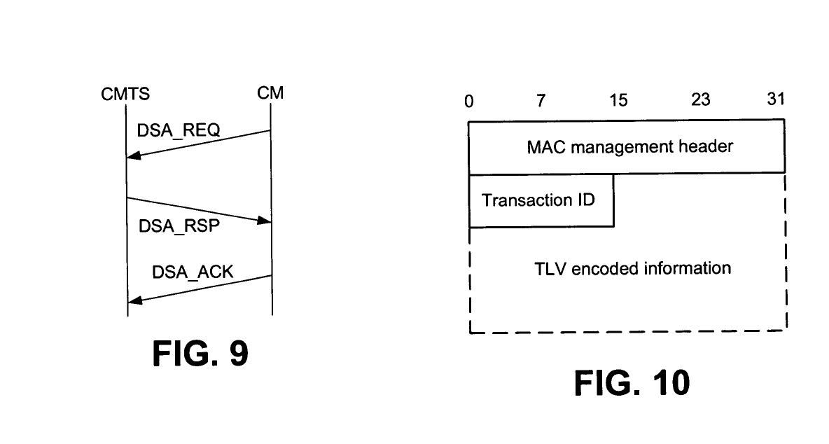

FIG. 9 illustrates a signal flow diagram for setting up and tearing down the ARQ service within a DOCSIS system according to one embodiment of the invention.

FIG. 10 is a diagram that illustrates layout of a MAC layer signal including a transaction ID and TLV encoded information.

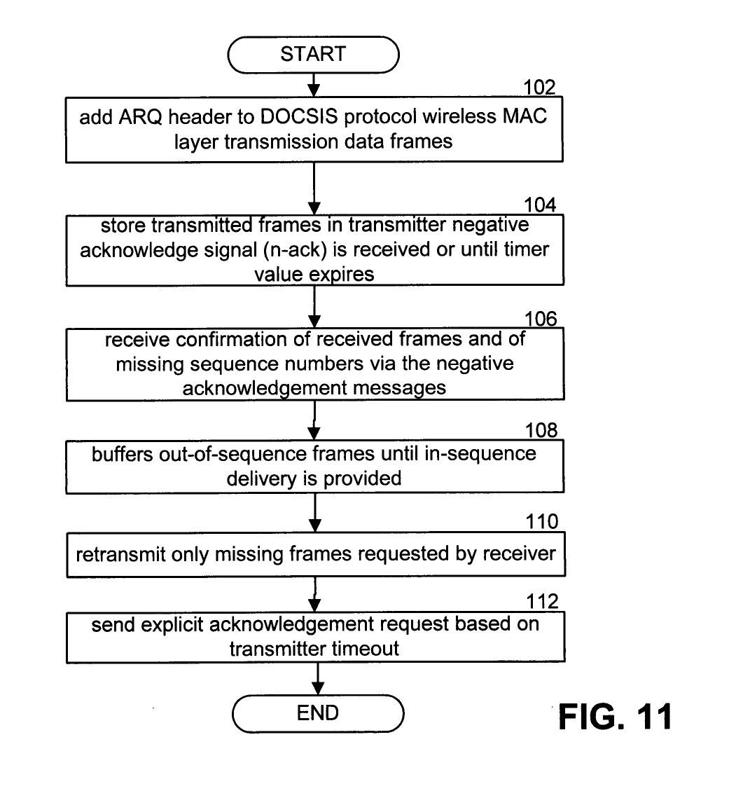

FIG. 11 is a flow chart illustrating operation of one embodiment of the invention. Initially, a transceiver adds ARQ header to DOCSIS protocol wireless MAC layer transmission data frames (step 102). Additionally, the transceiver stores transmitted frames in transmitter negative acknowledge signal (N-ACK) is received or until timer value expires (step 104). Generally, the transceiver receives confirmation of received frames and of missing sequence numbers via the negative acknowledgement messages (step 106). The transceiver further buffers out-of-sequence frames until in-sequence delivery is provided (step 108). The transceiver then retransmits only missing frames that are requested (identified) by an external receiver (step 110). The transceiver further sends explicit acknowledgement request based on transmitter timeout (step 112).

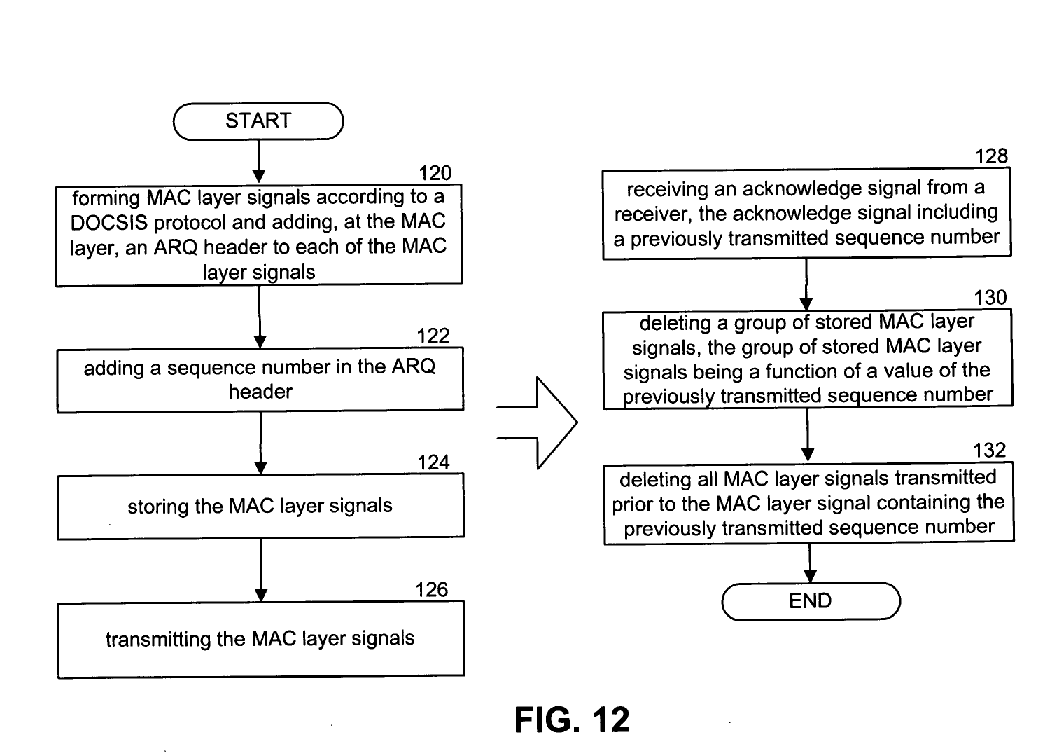

FIG. 12 is a flow chart illustrating one embodiment of the present invention. Generally, the invention includes forming MAC layer signals according to a DOCSIS protocol and adding, at the MAC layer, an ARQ header to each of the MAC layer signals (step 120). The invention further includes adding a sequence number in the ARQ header (step 122) and storing the MAC layer signals (step 124) and transmitting the MAC layer signals (step 126). The invention further includes receiving an acknowledge signal (or, more specifically, an N-ACK message) from a receiver, the acknowledge signal including a previously transmitted sequence number (step 128). Responsive, at least in part to receiving the previously transmitted sequence number, the invention includes deleting a group of stored MAC layer signals, the group of stored MAC layer signals being a function of a value of the previously transmitted sequence number (step 130). More specifically, in one embodiment of the invention, the step includes deleting all MAC layer signals transmitted prior to the MAC layer signal containing the previously transmitted sequence number (step 132).

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A method for transmitting wireless communication signals, comprising:
forming MAC layer signals according to a DOCSIS protocol;
adding, at the MAC layer, an ARQ header to each of the MAC layer signals;
transmitting the MAC layer signals; and
storing the MAC layer signals.

2. The method of claim 1 wherein the step of adding an ARQ header includes adding a sequence number in the ARQ header.

3. The method of claim 2 further including storing transmitted frames until a negative acknowledge signal is received.

4. The method of claim 2 further including receiving a non-acknowledge signal from a receiver, the non-acknowledge signal including a previously transmitted sequence number.

5. The method of claim 4 further including deleting a group of stored MAC layer signals, the group of stored MAC layer signals being a function of a value of the previously transmitted sequence number.

6. The method of claim 5 wherein the group comprises all MAC layer signals transmitted prior to the MAC layer signal containing the previously transmitted sequence number.

7. The method of claim 4 further including deleting a group of stored MAC layer signals after a specified period has elapsed since receiving the acknowledge signal.

8. The method of claim 4 further including retrieving a stored MAC layer signal that corresponds with the previously transmitted sequence number received in the acknowledge signal.

9. The method of claim 8 further including transmitting the stored MAC layer signal that corresponds with the previously transmitted sequence number received in the acknowledge signal.

10. The method of claim 9 further comprising deleting (flushing) all stored MAC layer signals that were transmitted prior to the stored MAC layer signal that corresponds with the previously transmitted sequence number received in the acknowledge signal.

11. The method of claim 4 further including determining whether the previously transmitted sequence number identified in the acknowledge signal is corresponds to a sequence number for a stored MAC layer signal.

12. The method of claim 11 further including deleting all stored MAC layer signals if the sequence number identified in the acknowledge signal does not correspond to a sequence number for a stored MAC layer signal.

13. A wireless transceiver for transmitting and receiving wireless communication signals, comprising:
a receiver portion that receives acknowledge signals transmitted by another device over a wireless medium; and
a transmitter portion, wherein the transmitter portion:
forms MAC layer signals according to a DOCSIS protocol;
adds, at the MAC layer, an ARQ header containing a sequence number to each of the MAC layer signals;
transmits the MAC layer signals;
stores the MAC layer signals; and
deletes at least one stored MAC layer signal.

14. The wireless transceiver of claim 13 wherein the wireless transceiver stores transmitted frames until a negative acknowledge signal is received.

15. The wireless transceiver of claim 13 wherein the wireless transceiver receives and responds to an acknowledge signal from a receiver, the acknowledge signal including a previously transmitted sequence number.

16. The wireless transceiver of claim 15 wherein the wireless transceiver deletes a goup of stored MAC layer signals, the group of stored MAC layer signals being a function of a value of the previously transmitted sequence number.

17. The wireless transceiver of claim 16 wherein the group comprises all MAC layer signals transmitted prior to the MAC layer signal containing the previously transmitted sequence number.

18. The wireless transceiver of claim 16 wherein the wireless transceiver deletes a group of stored MAC layer signals after a specified period has elapsed since receiving the acknowledge signal.

19. The wireless transceiver of claim 16 wherein the wireless transceiver retrieves a stored MAC layer signal that corresponds with the previously transmitted sequence number received in the acknowledge signal.

20. The wireless transceiver of claim 19 wherein the wireless transceiver transmits the stored MAC layer signal that corresponds with the previously transmitted sequence number received in the acknowledge signal.

21. The wireless transceiver of claim 20 wherein the wireless transceiver deletes (flushes) all stored MAC layer signals that were transmitted prior to the stored MAC layer signal that corresponds with the previously transmitted sequence number received in the acknowledge signal.

22. The wireless transceiver of claim 16 wherein the wireless transceiver determines whether the previously transmitted sequence number identified in the acknowledge signal is corresponds to a sequence number for a stored MAC layer signal.

23. The wireless transceiver of claim 22 wherein the wireless transceiver deletes all stored MAC layer signals if the sequence number identified in the acknowledge signal does not correspond to a sequence number for a stored MAC layer signal.

24. A fixed wireless device, comprising:
means for communicating over a wireless physical layer;
means for communicating over a DOCSIS MAC layer; and
means for embedding an ARQ protocol in said DOCSIS MAC layer.

25. The fixed wireless device of claim 24 wherein the means for communicating includes a receiver portion that receives non-acknowledge signals transmitted by another device over a wireless medium and a transmitter portion, wherein the transmitter portion:
forms MAC layer signals according to a DOCSIS protocol;
adds, at the MAC layer, an ARQ header containing a sequence number to each of the MAC layer signals;
transmits the MAC layer signals;
stores the MAC layer signals; and
deletes at least one stored MAC layer signal.

26. The fixed wireless device of claim 25 wherein the fixed wireless device stores transmitted frames until either a non-acknowledge signal is received or a timer expires.
